(19) United States
(12) Patent Application Publication
(10) Pub. No.: US 2026/0087273 A1
(43) Pub. Date: Mar. 26, 2026

(54) DATA PROCESSING SYSTEM AND DATA PROCESSING METHOD

(71) Applicant: Semiconductor Energy Laboratory Co., Ltd., Atsugi-shi (JP)

(72) Inventors: Junpei MOMO, Sagamihara (JP); Ayami HARA, Kawasaki (JP)

(21) Appl. No.: 19/324,463

(22) Filed: Sep. 10, 2025

(30) Foreign Application Priority Data
Sep. 25, 2024 (JP) 2024-165855

(51) Int. Cl. G06F 40/58; G06F 16/93

(52) U.S. Cl. CPC G06F 40/58; G06F 16/93

(57) ABSTRACT

A novel data processing system that is highly convenient, useful, or reliable. The data processing system is composed of three components. A first component has a function of receiving an original document and a translated document and providing a difference. A second component has a function of generating a question and answers with use of a large language model and transmitting a difference. A third component has a function of receiving and sharing various kinds of data and transmitting a prompt. The third component includes two subcomponents: a first subcomponent has a function of sharing the points to be noted with use of the database and the management system, and a second subcomponent has a function of creating a prompt. Each of the prompts includes an original document, a translated document, a question, an answer, a difference, and the like. These prompts are shared in the system and processed.

### BACKGROUND OF THE INVENTION

### 1. Field of the Invention

One embodiment of the present invention relates to a data processing system, a data processing method, or a semiconductor device.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Thus, more specifically, examples of the technical field of one embodiment of the present invention disclosed in this specification include a data processing device, a semiconductor device, a memory device, a driving method thereof, and a manufacturing method thereof.

### 2. Description of the Related Art

In recent years, language models using neural networks have been actively developed, and especially large language models (LLM) have attracted attention. An LLM is a natural language processing model learned using a large amount of data. With an LLM, for example, an interactive model that gives an answer to a user's instruction can be achieved. In Non-Patent Document 1, generative pre-trained transformer 4 (GPT-4, registered trademark) is disclosed as an LLM, and ChatGPT is disclosed as an interactive model.

By utilizing a large language model, the capability of a natural language processing model has been significantly increased. On the other hand, owing to the expansion of the language model, it is difficult to incorporate and operate a language model on one's own from the aspect of facilities and costs. Accordingly, utilizing an external service that provides a language model is one of the utility forms of a language model.

### REFERENCE

### Non-Patent Document

[Non-Patent Document 1] Summary of CatGPT/GPT-4 Research and Perspective Towards the Future of Large Language Models, Yiheng Liu et al., (submitted on 4 Apr. 2023) [online], Internet URL: https://arxiv.org/abs/2304.01852

### SUMMARY OF THE INVENTION

An object of one embodiment of the present invention is to provide a novel data processing system that is highly convenient, useful, or reliable. Another object is to provide a novel data processing method that is highly convenient, useful, or reliable. Another object is to provide a novel data processing system, a novel data processing method, or a novel semiconductor device.

Note that the description of these objects does not preclude the existence of other objects. One embodiment of the present invention does not need to achieve all these objects. Other objects will be apparent from and can be derived from the description of the specification, the drawings, the claims, and the like.

(1) One embodiment of the present invention is a data processing system including a first component, a second component, and a third component.

The first component has a function of receiving an original document and a translated document and transmitting them to the third component and a function of receiving a difference and providing it. The original document is written in a first language, and the translated document is a translated document of the original document from the first language into a second language. The difference includes a difference between the original document and the translated document.

The second component has a function of receiving a first prompt and transmitting a question to the third component, a function of receiving a second prompt and transmitting a first answer to the third component, a function of receiving a third prompt and transmitting a second answer to the third component, a function of receiving a fourth prompt and transmitting the difference to the third component, and a function of performing processing using a large language model. The large language model has a function of generating the question in accordance with the first prompt, a function of generating the first answer in accordance with the second prompt, a function of generating the second answer in accordance with the third prompt, and a function of generating the difference in accordance with the fourth prompt.

The third component has a function of receiving the original document, the translated document, the question, the first answer, the second answer, and the difference and sharing them in the third component, a function of transmitting the first prompt, the second prompt, the third prompt, and the fourth prompt to the second component, and a function of transmitting the difference to the first component.

The third component includes a first subcomponent and a second subcomponent.

The first subcomponent has a function of performing processing using a database and a management system and a function of sharing a point to be noted in the third component. Note that the database stores the point to be noted. The point to be noted is a matter that requires attention in translation from the first language into the second language.

The second subcomponent has a function of creating the first prompt, the second prompt, the third prompt, and the fourth prompt.

The first prompt includes a first instruction, the original document, and the point to be noted. The first instruction includes a procedure for generating the question related to the point to be noted, and the question can be answered from the original document. The second prompt includes a second instruction, the question, and the original document. The second instruction includes a procedure for generating the first answer to the question based on description of the original document. The third prompt includes a third instruction, the question, and the translated document. The third instruction includes a procedure for generating the second answer to the question based on description of the translated document. The fourth prompt includes a fourth instruction and a pair of answers. The fourth instruction includes a procedure for generating the difference from the pair of answers, and the pair of answers includes the first answer and the second answer.

Thus, in consideration of the point to be noted in translation from the first language into the second language, a question that inquires about the content of the original document can be generated. By comparing the first and the second answers to the question, a difference generated between the original document and the translated document can be identified. For example, it is possible to provide a difference to a user of the data processing system to ask whether the translated document needs to be corrected or not. As a result, a novel data processing system that is highly convenient, useful, or reliable can be provided.

(2) Another embodiment of the present invention is the data processing system in which the first component has a function of receiving a corrected document and providing the corrected document.

The second component has a function of receiving a fifth prompt and transmitting the corrected document to the third component. The large language model has a function of generating the corrected document in accordance with the fifth prompt.

The third component has a function of transmitting the fifth prompt to the second component.

The second subcomponent has a function of creating the fifth prompt. The fifth prompt includes a fifth instruction, the translated document, and the difference. The fifth instruction includes a procedure for generating the corrected document from the translated document with reference to the difference.

Thus, the corrected document can be generated from the translated document with reference to the difference, which is identified by comparison between the first and the second answers to the question, generated between the original document and the translated document. As a result, a novel data processing system that is highly convenient, useful, or reliable can be provided.

(3) Another embodiment of the present invention is the data processing system in which the first component has a function of receiving information and the point to be noted and transmitting them to the third component. Note that the information includes information specifying the first language and the second language.

The third component has a function of receiving the information and the point to be noted and sharing them in the third component.

The first subcomponent has a function of linking the information and the point to be noted and registering them in the database with use of the management system.

Thus, for example, a user of the information processing system can register the point to be noted in translation from the first language into the second language in the data processing system. For example, the user of the data processing system can input information to the data processing system to call up the point to be noted. As a result, a novel data processing system that is highly convenient, useful, or reliable can be provided.

(4) Another embodiment of the present invention is the data processing system in which the first component has a function of receiving information and transmitting it to the third component. Note that the information includes information specifying the first language and the second language.

The second component has a function of receiving a sixth prompt and transmitting explanation to the third component and has a function of receiving a seventh prompt and transmitting the point to be noted to the third component. The large language model has a function of generating the explanation in accordance with the sixth prompt and generating the point to be noted in accordance with the seventh prompt.

The third component has a function of receiving the information and sharing it in the third component and has a function of transmitting the sixth prompt and the seventh prompt to the second component.

The second subcomponent has a function of creating the sixth prompt and the seventh prompt. The sixth prompt includes a sixth instruction and the information. The sixth instruction includes a procedure for extracting a feature of the first language and a feature of the second language to generate the explanation. The seventh prompt includes a seventh instruction and the explanation. The seventh instruction includes a procedure for generating the point to be noted in translation from the first language into the second language in consideration of the explanation.

The first subcomponent has a function of linking the information and the point to be noted and registering them in the database with use of the management system.

Thus, the point to be noted in translation from the first language into the second language can be summarized in consideration of the features of the first language and the second language. As a result, a novel data processing system that is highly convenient, useful, or reliable can be provided.

(5) One embodiment of the present invention is a data processing method including a first phase. Note that the first phase includes a first step to a twentieth step.

In the first step of the first phase, a first component receives an original document, a translated document, and information and transmits them to a second component. The original document is written in a first language, and the translated document is a translated document of the original document from the first language into the second language. The information includes information specifying the first language and the second language.

In the second step of the first phase, the second component receives the original document, the translated document, and the information and shares them in the second component. The second component includes a first subcomponent and a second subcomponent. The first subcomponent has a function of performing processing with use of a database and a management system. The database stores point to be noted. The point to be noted are matters that require attention in translation from the first language into the second language.

In the third step of the first phase, the first subcomponent specifies the point to be noted from the information with use of the management system and shares it in the second component.

In the fourth step of the first phase, the second subcomponent creates a first prompt and transmits it to a third component. The first prompt includes a first instruction, the original document, and the point to be noted. The first instruction includes a procedure for generating a question related to the point to be noted. The question can be answered from description of the original document.

In the fifth step of the first phase, the third component receives the first prompt and generates the question with use of a large language model.

In the sixth step of the first phase, the third component transmits the question to the second component.

In the seventh step of the first phase, the second component receives the question and shares it in the second component.

In the eighth step of the first phase, the second subcomponent creates a second prompt and transmits it to the third component. The second prompt includes a second instruction, the question, and the original document. The second instruction includes a procedure for generating a first answer to the question based on description of the original document.

In the ninth step of the first phase, the third component receives the second prompt and generates the first answer with use of the large language model.

In the tenth step of the first phase, the third component transmits the first answer to the second component.

In the eleventh step of the first phase, the second component receives the first answer and shares it in the second component.

In the twelfth step of the first phase, the second subcomponent creates a third prompt and transmits it to the third component. The third prompt includes a third instruction, the question, and the translated document. The third instruction includes a procedure for generating a second answer to the question based on description of the translated document.

In the thirteenth step of the first phase, the third component receives the third prompt and generates the second answer with use of the large language model.

In the fourteenth step of the first phase, the third component transmits the second answer to the second component.

In the fifteenth step of the first phase, the second component receives the second answer and shares it in the second component.

In the sixteenth step of the first phase, the second subcomponent creates a fourth prompt and transmits it to the third component. The fourth prompt includes a fourth instruction and a pair of answers. The fourth instruction includes a procedure for generating a difference from the pair of answers. The pair of answers includes the first answer and the second answer.

In the seventeenth step of the first phase, the third component receives the fourth prompt and generates the difference with use of the large language model.

In the eighteenth step of the first phase, the third component transmits the difference to the second component.

In the nineteenth step of the first phase, the second component receives the difference and transmits it to the first component.

In the twentieth step of the first phase, the first component receives the difference and provides it.

Thus, in consideration of the point to be noted in translation from the first language into the second language, a question that inquires about the content of the original document can be generated. By comparing the first and the second answers to the question, a difference generated between the original document and the translated document can be identified. For example, it is possible to provide a difference to a user of the data processing system to ask whether the translated document needs to be corrected or not. As a result, a novel data processing method that is highly convenient, useful, or reliable can be provided.

(6) Another embodiment of the present invention is the data processing method further including a second phase. The second phase follows the first phase, and the second phase includes a first step to a sixth step.

In the first step of the second phase, the second component shares the difference in the second component.

In the second step of the second phase, the second subcomponent creates a fifth prompt and transmits it to the third component. The fifth prompt includes a fifth instruction, the translated document, and the difference. The fifth instruction includes a procedure for generating a corrected document from the translated document with reference to the difference.

In the third step of the second phase, the third component receives the fifth prompt and generates the corrected document with use of the large language model.

In the fourth step of the second phase, the third component transmits the corrected document to the second component.

In the fifth step of the second phase, the second component receives the corrected document and transmits it to the first component.

In the sixth step of the second phase, the first component receives the corrected document and provides it.

Thus, the corrected document can be generated from the translated document with reference to the difference, which is identified by comparison between the first and the second answers to the question, generated between the original document and the translated document. As a result, a novel data processing method that is highly convenient, useful, or reliable can be provided.

(7) Another embodiment of the present invention is the data processing method further including a third phase. The first phase follows the third phase, and the third phase includes a first step to a third step.

In the first step of the third phase, the first component receives the information and the point to be noted and transmits them to the second component.

In the second step of the third phase, the second component receives the information and the point to be noted and shares them in the second component.

In the third step of the third phase, the first subcomponent stores the information and the point to be noted in the database with use of the management system.

Thus, for example, a user of the information processing system can register the point to be noted in translation from the first language into the second language in the data processing system. For example, the user of the data processing system can input information to the data processing system to call up the point to be noted. As a result, a novel data processing method that is highly convenient, useful, or reliable can be provided.

(8) Another embodiment of the present invention is the data processing method further including a third phase. The first phase follows the third phase, and the third phase includes a first step to an eleventh step.

In the first step of the third phase, the first component receives the information and transmits it to the second component.

In the second step of the third phase, the second component receives the information and shares it in the second component.

In the third step of the third phase, the second subcomponent creates a sixth prompt and transmits it to the third component. The sixth prompt includes a sixth instruction and the information. The sixth instruction includes a procedure for extracting a feature of the first language and a feature of the second language to generate explanation.

In the fourth step of the third phase, the third component receives the sixth prompt and generates the explanation with use of the large language model.

In the fifth step of the third phase, the third component transmits the explanation to the second component.

In the sixth step of the third phase, the second component receives the explanation and shares it in the second component.

In the seventh step of the third phase, the second subcomponent creates a seventh prompt and transmits it to the third component. The seventh prompt includes a seventh instruction and the explanation. The seventh instruction includes a procedure for generating the point to be noted in translation from the first language into the second language in consideration of the explanation.

In the eighth step of the third phase, the third component receives the seventh prompt and generates the point to be noted with use of the large language model.

In the ninth step of the third phase, the third component transmits the point to be noted to the second component.

In the tenth step of the third phase, the second component receives the point to be noted and shares it in the second component.

In the eleventh step of the third phase, the first subcomponent links the information and the point to be noted and registers them in the database with use of the management system.

Thus, the point to be noted in translation from the first language into the second language can be summarized in consideration of the features of the first language and the second language. As a result, a novel data processing method that is highly convenient, useful, or reliable can be provided.

One embodiment of the present invention can provide a novel data processing system that is highly convenient, useful, or reliable. Alternatively, a novel data processing method that is highly convenient, useful, or reliable can be provided. Alternatively, a novel data processing system, a novel data processing method, or a novel semiconductor device can be provided.

Note that the description of these effects does not preclude the existence of other effects. One embodiment of the present invention does not need to have all the effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1 illustrates a configuration of a data processing system of an embodiment.

FIG. 2 illustrates a configuration of a component used in a data processing system of an embodiment.

FIG. 3 illustrates a configuration of a prompt used in a data processing system of an embodiment.

FIGS. 4A and 4B each illustrate a configuration of a prompt used in a data processing system of an embodiment.

FIGS. 5A and 5B each illustrate a configuration of a prompt used in a data processing system of an embodiment.

FIGS. 6A and 6B each illustrate a configuration of a prompt used in a data processing system of an embodiment.

FIG. 7 illustrates a configuration of a data processing system of an embodiment.

FIG. 8 illustrates a configuration of a data processing device used for a data processing system of an embodiment.

FIG. 9 illustrates a data processing method of an embodiment.

FIG. 10 illustrates a data processing method of an embodiment.

FIG. 11 illustrates a data processing method of an embodiment.

FIG. 12 illustrates a data processing method of an embodiment.

FIG. 13 illustrates a data processing method of an embodiment.

FIG. 14 illustrates a data processing method of an embodiment.

FIG. 15 illustrates a data processing method of an embodiment.

### DETAILED DESCRIPTION OF THE INVENTION

The data processing system of one embodiment of the present invention includes a first component, a second component, and a third component. The first component has a function of receiving an original document and a translated document and transmitting them to the third component and a function of receiving a difference and providing it. The original document is written in a first language, and the translated document is a translated document of the original document from the first language into a second language. The difference includes a difference between the original document and the translated document.

The second component has a function of receiving a first prompt and transmitting a question to the third component, a function of receiving a second prompt and transmitting a first answer to the third component, a function of receiving a third prompt and transmitting a second answer to the third component, a function of receiving a fourth prompt and transmitting the difference to the third component, and a function of performing processing using a large language model. The large language model has a function of generating the question in accordance with the first prompt, a function of generating the first answer in accordance with the second prompt, a function of generating the second answer in accordance with the third prompt, and a function of generating the difference in accordance with the fourth prompt.

The third component has a function of receiving the original document, the translated document, the question, the first answer, the second answer, and the difference and sharing them in the third component, a function of transmitting the first prompt, the second prompt, the third prompt, and the fourth prompt to the second component, and a function of transmitting the difference to the first component. The third component includes a first subcomponent and a second subcomponent.

The first subcomponent has a function of performing processing using a database and a management system and a function of sharing points to be noted in the third component. Note that the database stores the points to be noted. The points to be noted are a matter that requires attention in translation from the first language into the second language.

The second subcomponent has a function of creating the first prompt, the second prompt, the third prompt, and the fourth prompt. The first prompt includes a first instruction, the original document, and the points to be noted. The first instruction includes a procedure for generating the question related to the points to be noted, and the question can be answered from the original document. The second prompt includes a second instruction, the question, and the original document. The second instruction includes a procedure for generating the first answer to the question based on description of the original document. The third prompt includes a third instruction, the question, and the translated document. The third instruction includes a procedure for generating the second answer to the question based on description of the translated document. The fourth prompt includes a fourth instruction and a pair of answers. The fourth instruction includes a procedure for generating the difference from the pair of answers, and the pair of answers includes the first answer and the second answer.

Thus, in consideration of the points to be noted in translation from the first language into the second language, a question that inquires about the content of the original document can be generated. By comparing the first and the second answers to the question, a difference generated between the original document and the translated document can be identified. For example, it is possible to provide a difference to a user of the data processing system to ask whether the translated document needs to be corrected or not. As a result, a novel data processing system that is highly convenient, useful, or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numerals in different drawings, and the description thereof is not repeated.

Ordinal numbers such as “first” and “second” in this specification and the like are used in order to avoid confusion among components. Thus, the terms do not limit the number of components or the order of components (e.g., the order of steps or the stacking order of layers). A term without an ordinal number in this specification and the like may be described with an ordinal number in a claim in order to avoid confusion among components. A term with an ordinal number in this specification and the like may be described with a different ordinal number in a claim. A term with an ordinal number in this specification and the like may be described without an ordinal number in a claim.

Although a block diagram in which components are classified by their functions and shown as independent blocks is shown in the drawing attached to this specification, it is difficult to completely separate actual components according to their functions and one component can relate to a plurality of functions.

### Embodiment 1

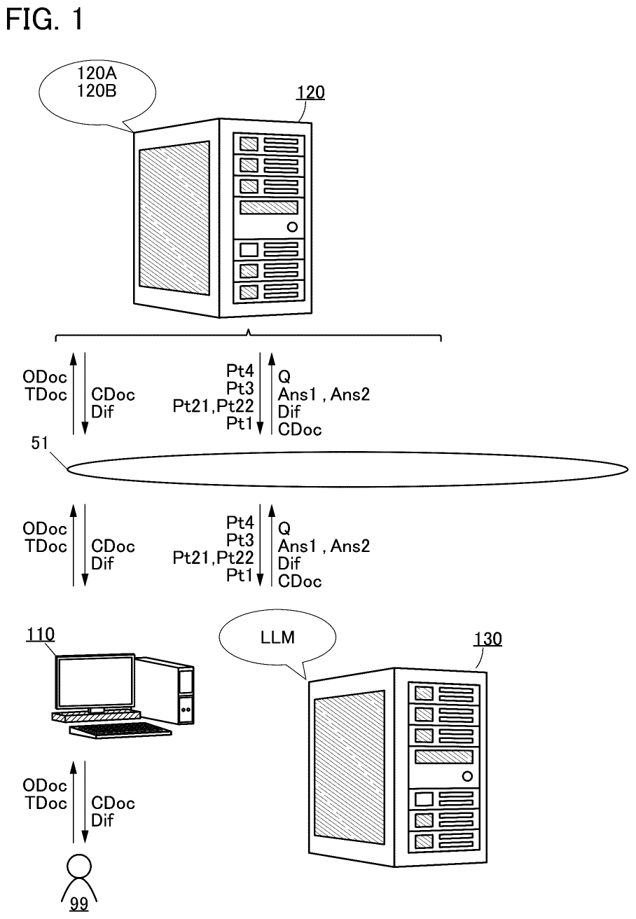

In this embodiment, a data processing system of one embodiment of the present invention will be described with reference to FIG. 1 to FIG. 8.

FIG. 1 illustrates a configuration of a data processing system of an embodiment.

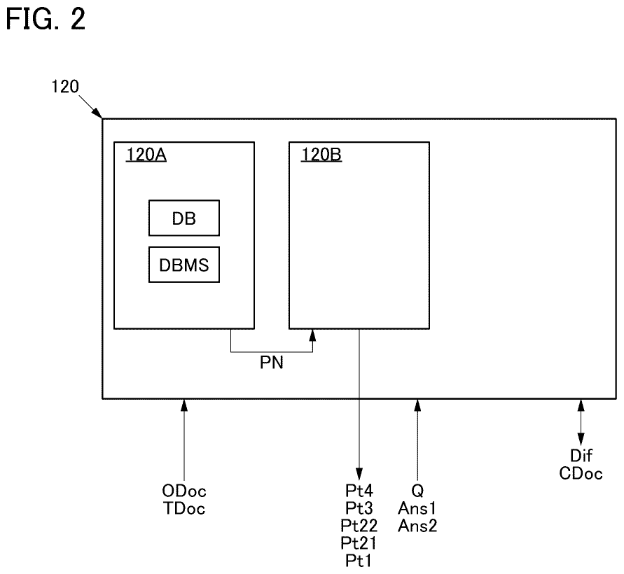

FIG. 2 illustrates a configuration of a component used in the data processing system of the embodiment.

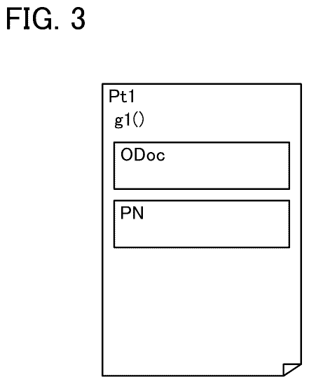

FIG. 3 illustrates a configuration of a prompt transmitted and received inside the data processing system of the embodiment.

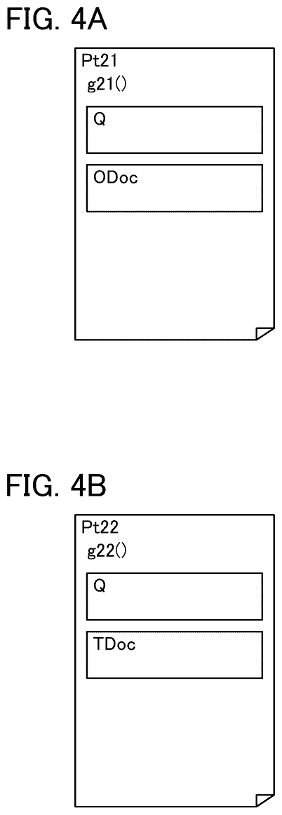

FIGS. 4A and 4B each illustrate a configuration of a prompt that is transmitted and received inside the data processing system of the embodiment.

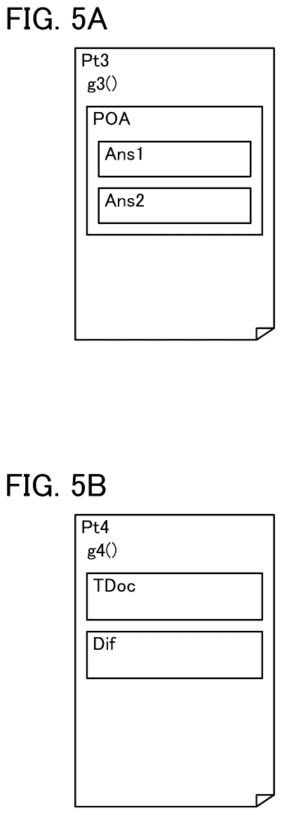

FIGS. 5A and 5B each illustrate a configuration of a prompt that is transmitted and received inside the data processing system of the embodiment.

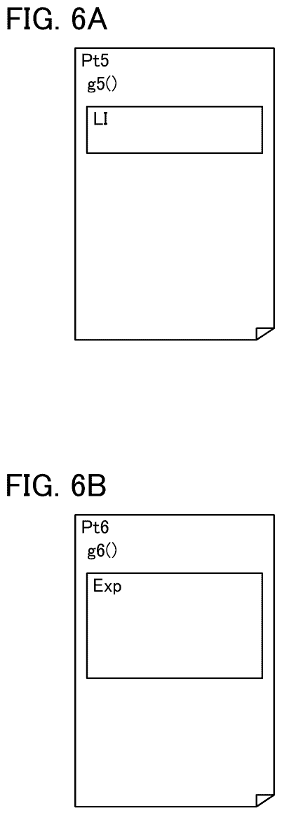

FIGS. 6A and 6B each illustrate a configuration of a prompt that is transmitted and received inside the data processing system of the embodiment.

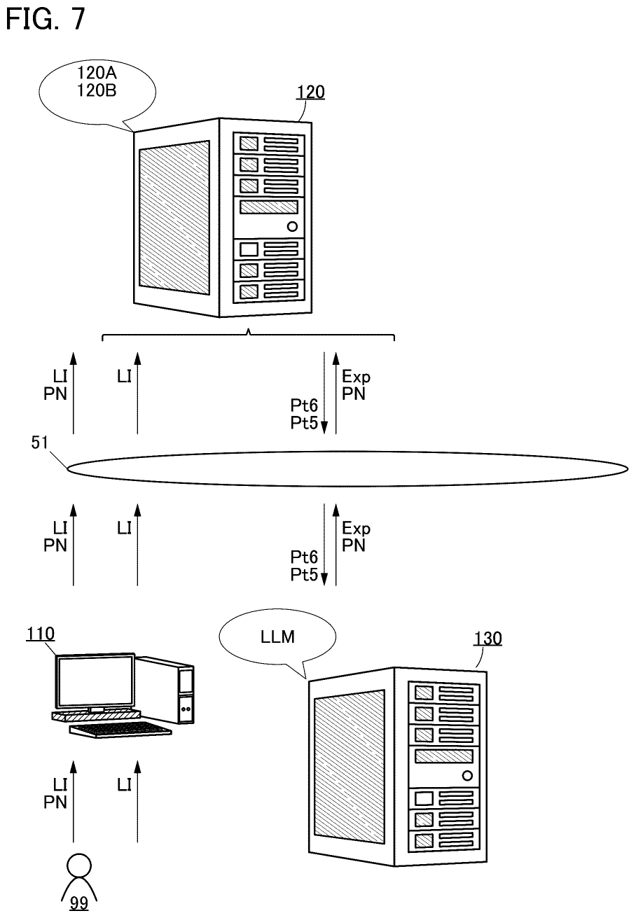

FIG. 7 illustrates a configuration of a data processing system of an embodiment.

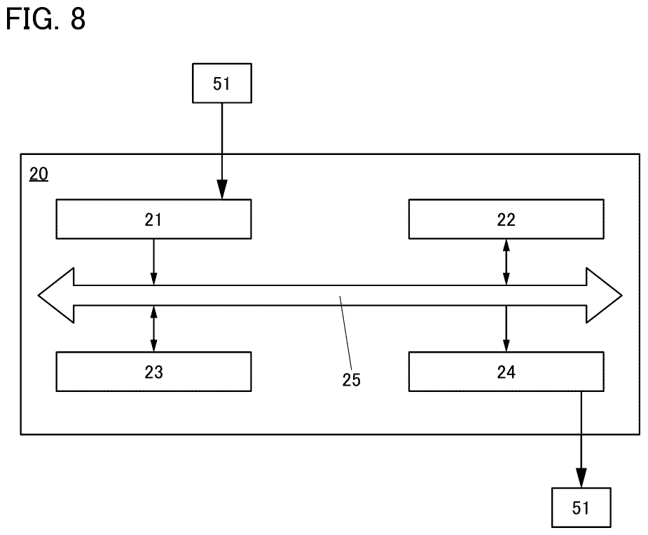

FIG. 8 is a block diagram illustrating a configuration of a data processing device that can be used for the data processing system of the embodiment.

### <Configuration Example 1 of Data Processing System>

The data processing system described in this embodiment includes a component 110, a component 130, and a component 120 (see FIG. 1).

A data processing device having a function of the component 110, a data processing device having a function of the component 130, and a data processing device having a function of the component 120 each include an arithmetic device and a communication device. The communication devices can be connected to each other through, for example, a network 51, to form the data processing system of one embodiment of the present invention.

### <Configuration Example 1 of Component 110>

The component 110 has a function of receiving the original document ODoc and the translated document TDoc and transmitting them to the component 120, and a function of receiving a difference Dif and providing it to a user 99 of the data processing system, for example. Specifically, with use of an output device such as a display device, a speaker, a printer, or a memory device, the difference Dif is provided to the user 99 of the data processing system.

Note that the original document ODoc is written in the language Lng1. The translated document TDoc is the original document ODoc translated from the language Lng1 into the language Lng2. In other words, the translated document TDoc is a document obtained by translating the description of the original document ODoc from the language Lng1 into the language Lng2. The difference Dif includes a difference between the original document ODoc and the translated document TDoc. For example, when the original document ODoc written in the language Lng1 is translated and described in the language Lng2, the difference Dif includes a difference in nuance generated between the original document ODoc and the translated document TDoc.

For example, the user 99 of the data processing system inputs the original document ODoc and the translated document TDoc to the component 110. Specifically, the user 99 of the data processing system inputs them to the component 110 with use of an input device such as a keyboard, a mouse, an eye-gaze input device, or a microphone.

### <Configuration Example 1 of Component 130>

The component 130 has a function of receiving the prompt Pt1 and transmitting a question Q to the component 120, a function of receiving a prompt Pt21 and transmitting an answer Ans1 to the component 120, a function of receiving a prompt Pt22 and transmitting an answer Ans2 to the component 120, a function of receiving a prompt Pt3 and transmitting the difference Dif to the component 120, and a function of performing processing using the large language model LLM.

### <<Configuration Example 1 of Large Language Model LLM>>

The large language model LLM has a function of generating the question Q in accordance with the prompt Pt1, a function of generating the answer Ans1 in accordance with the prompt Pt21, a function of generating the answer Ans2 in accordance with the prompt Pt22, and a function of generating the difference Dif in accordance with the prompt Pt3. For example, a large language model such as GPT-3 (registered trademark), GPT-3.5, GPT-4 (registered trademark), LaMDA, Llama2, or Llama3 can be used as the large language model LLM.

### <Configuration Example 1 of Component 120>

The component 120 has a function of receiving the original document ODoc, the translated document TDoc, the question Q, the answer Ans1, the answer Ans2, and the difference Dif and sharing them in the component 120.

Furthermore, the component 120 has a function of transmitting the prompt Pt1, the prompt Pt21, the prompt Pt22, and the prompt Pt3 to the component 130 and a function of transmitting the difference Dif to the component 110.

Note that the component 120 includes a subcomponent 120A and a subcomponent 120B (see FIG. 2). In this specification, a structure having a single function or a plurality of functions is referred to as a component or a subcomponent for description convenience. When a component includes a plurality of subcomponents and has a function of sharing information internally, the plurality of subcomponents can utilize the same information.

### <<Configuration Example 1 of Subcomponent 120A>>

The subcomponent 120A has a function of executing processing using a database DB and a management system DBMS. In addition, the subcomponent 120A has a function of sharing points to be noted PN inside the component 120.

For example, the text in the next paragraph can be used as the points to be noted PN.

“In the translation from Japanese to English, the following points need to be noted.
1) The difference in the letter system: Japanese letters use Chinese characters, hiragana, and katakana, whereas English letters use alphabets; it is necessary to avoid mistranslation and unnatural expression due to the difference in the letter system.
2) The difference in the word order: the SOV (Subject-Object-Verb) type is used in Japanese and the SVO (Subject-Verb-Object) type is used in English; thus, components of a sentence need to be changed appropriately. In particular, since the positions of the subject and the object are different, attention needs to be taken at the time of translation.
3) The difference in the honorific system: Japanese has a complicated honorific system and English does not have such a system; thus, it is necessary to appropriately convert expressions of the honorific terms.
4) Processing of homonyms: Japanese has a large number of homonyms while English has a relatively smaller number of words with the same pronunciation and different meanings; thus, an appropriate word needs to be selected in consideration of the context and the situation in translation.
5) The difference in cultural background: Japanese and English are based on different cultural backgrounds, and it is necessary to appropriately transmit the cultural nuances and the implicit knowledge in translation.
6) Vocabulary selection: in Japanese and English, different words need to be selected depending on the nuances and contexts. For example, the phrase “I like it very much” in Japanese is translated into the expression “I love it”, “I'm crazy about it”, or the like in English.
7) Idiomatic expressions: Japanese has many idioms, and English also has many idioms; however, appropriate idioms need to be selected in translation.
8) Nuances of politeness: in Japanese, honorific language and courteous language are used for expressing respect; however, in English, the nuance of politeness is expressed by different ways, which is necessary to be noted in translation.

By keeping in mind the above-described points and considering the cultural background and context, natural English translation can be achieved.”

The database DB stores the points to be noted PN. Note that the points to be noted PN are matters that require attention in translating from the language Lng1 into the language Lng2.

### <<Configuration Example 1 of Subcomponent 120B>>

The subcomponent 120B has a function of creating the prompt Pt1, the prompt Pt21, the prompt Pt22, and the prompt Pt3.

### [Configuration Example of Prompt Pt1]

The prompt Pt1 includes an instruction g1 ( ), the original document ODoc, and the points to be noted PN (see FIG. 3).

The instruction g1 ( ) includes a procedure for generating the question Q relating to the points to be noted PN. Note that the question Q is a question that can be answered from the description of the original document ODoc.

For example, the text in the next paragraph can be used as the prompt Pt1. When there are a plurality of points to be noted PN, a question about each point can be created.

“In consideration of the points to be noted PN, make a plurality of question sentences related to precautions for translating description of the original document ODoc. The answer to the question can be made based on the description of the original document ODoc.”

### [Configuration Example of Prompt Pt21]

The prompt Pt21 includes an instruction g21 ( ), the question Q, and the original document ODoc (see FIG. 4A).

The instruction g21 ( ) includes a procedure for generating the answer Ans1 to the question Q from the description of the original document ODoc.

For example, the text in the next paragraph can be used as the prompt Pt21.

“Original document: the original document ODoc

Answer to the following question. The answer is made based on the original document ODoc.

Question: the question Q.”

[Configuration example of prompt Pt22]

The prompt Pt22 includes an instruction g22 ( ), the question Q, and the translated document TDoc (see FIG. 4B).

The instruction g22 ( ) includes a procedure for generating the answer Ans2 to the question Q from the description of the translated document TDoc.

For example, the text in the next paragraph can be used as the prompt Pt21.

“Translated document: the translated document TDoc

Answer to the following question. The answer is made based on the translated document.

Question: the question Q.”

### [Configuration Example of Prompt Pt3]

The prompt Pt3 includes an instruction g3 ( ) and a pair of answers POA (see FIG. 5A).

The instruction g3 ( ) includes a procedure for generating the difference Dif from the pair of answers POA. Note that the pair of answers POA includes an answer Ans1 and an answer Ans2 for one question Q.

For example, the text in the next paragraph can be used as the prompt Pt3.

“Indicate whether the answer Ans1 and the answer Ans2 have different meanings, by explaining the difference between them.”

Thus, with the points to be noted PN in mind in translation from the language Lng1 into the language Lng2, the question Q that inquires about the content described in the original document Odoc can be generated. Furthermore, by comparing the answers Ans1 and Ans2 to the question Q, the difference Dif generated between the original document ODoc and the translated document TDoc can be identified. For example, it is possible to provide the difference Dif to a user of the data processing system and ask the user whether the correction of the translated document TDoc is necessary. As a result, a novel data processing system that is highly convenient, useful, or reliable can be provided.

### <Configuration Example 2 of Component 110>

The component 110 has a function of receiving the corrected document CDoc and transmitting it to the user 99 of the data processing system, for example. Specifically, with use of an output device such as a display device, a speaker, a printer, or a memory device, the corrected document CDoc is provided to the user 99 of the data processing system.

### <Configuration Example 2 of Component 130>

The component 130 has a function of receiving the prompt Pt4 and transmitting the corrected document CDoc to the component 120.

### <<Configuration Example 2 of Large Language Model LLM>>

The large language model LLM has a function of generating the corrected document CDoc in accordance with the prompt Pt4.

### <Configuration Example 2 of Component 120>

The component 120 has a function of transmitting the prompt Pt4 to the component 130.

### <<Configuration Example 2 of Subcomponent 120B>>

The subcomponent 120B has a function of creating the prompt Pt4.

### [Configuration Example of Prompt Pt4]

The prompt Pt4 includes an instruction g4 ( ), the translated document TDoc, and the difference Dif (see FIG. 5B).

The instruction g4 ( ) includes a procedure for generating a corrected document CDoc from the translated document TDoc with reference to the difference Dif.

For example, the text in the next paragraph can be used as the prompt Pt4.
“Original document: the original document ODoc
Translated document: the translated document TDoc
Comment on the difference between the original document and the translated document: the difference Dif
Correct the translated document with reference to the comments regarding the differences in the translated document and the original document.”

Accordingly, the corrected document CDoc can be generated from the translated document TDoc with reference to the difference Dif generated between the original document Odoc and the translated document Tdoc which is identified by comparing the answers Ans1 and Ans2 to the question Q. As a result, a novel data processing system that is highly convenient, useful, or reliable can be provided.

### <Configuration Example 3 of Component 110>

The component 110 has a function of receiving information LI and the points to be noted PN and transmitting them to the component 120 (see FIG. 7). Note that the information LI includes information specifying the language Lng1 and the language Lng2.

For example, the user 99 of the data processing system inputs the information LI and the points to be noted PN to the component 110. Specifically, the user 99 of the data processing system inputs them to the component 110 with use of an input device such as a keyboard, a mouse, or an eye-gaze input device.

### <Configuration Example 3 of Component 120>

The component 120 has a function of receiving the information LI and the points to be noted PN and sharing them in the component 120.

### <<Configuration Example 2 of Subcomponent 120A>>

The subcomponent 120A has a function of linking the information LI and the points to be noted PN and registering them in the database DB with use of the management system DBMS.

Thus, for example, a user of the information processing system can register the points to be noted PN in translation from the language Lng1 into the language Lng2 in the data processing system. For example, the user of the data processing system can input the information LI to the data processing system to call up the points to be noted PN. As a result, a novel data processing system that is highly convenient, useful, or reliable can be provided.

### <Configuration Example 4 of Component 110>

The component 110 has a function of receiving the information LI and transmitting it to the component 120. Note that the information LI includes information specifying the language Lng1 and the language Lng2.

For example, the user 99 of the data processing system inputs the information LI to the component 110. Specifically, the user 99 of the data processing system inputs it to the component 110 with use of an input device such as a keyboard, a mouse, or an eye-gaze input device.

### <Configuration Example 3 of Component 130>

The component 130 has a function of receiving a prompt Pt5 and transmitting explanation Exp to the component 120 and a function of receiving a prompt Pt6 and transmitting the points to be noted PN to the component 120.

### <<Configuration Example 3 of Large Language Model LLM>>

The large language model LLM has a function of generating the explanation Exp in accordance with the prompt Pt5 and a function of generating the points to be noted PN in accordance with the prompt Pt6.

### <Configuration Example 4 of Component 120>

The component 120 has a function of receiving the information LI and sharing it in the component 120 and a function of transmitting the prompt Pt5 and the prompt Pt6 to the component 130.

### <<Configuration Example 3 of Subcomponent 120B>>

The subcomponent 120B has a function of creating the prompt Pt5 and the prompt Pt6.

### [Configuration Example of Prompt Pt5]

The prompt Pt5 includes an instruction g5 ( ) and the information LI (see FIG. 6A). Note that the instruction g5 ( ) includes a procedure for generating the explanation Exp by extracting the feature of the language Lng1 and the feature of the language Lng2.

For example, in the case where the large language model LLM has learned a plurality of natural languages, the text in the next paragraph can be used as the prompt Pt5.

“Describe the features of Japanese and the features of English.”

### [Configuration Example of Prompt Pt6]

The prompt Pt6 includes an instruction g6 ( ) and the explanation Exp (see FIG. 6B).

The instruction g6 ( ) includes a procedure for generating the points to be noted PN in translation from the language Lng1 into the language Lng2 in consideration of the explanation Exp.

For example, the text in the next paragraph can be used as the prompt Pt6.

“In consideration of the explanation Exp, describe points that should be noted in translation from Japanese into English.”

### <<Configuration Example 3 of Subcomponent 120A>>

The subcomponent 120A has a function of linking the information LI and the points to be noted PN and registering them in the database DB with use of the management system DBMS.

Thus, in consideration of the features of the language Lng1 and the language Lng2, the points to be noted PN in translation from the language Lng1 into the language Lng2 can be summarized. As a result, a novel data processing system that is highly convenient, useful, or reliable can be provided.

### <Configuration Example 2 of Data Processing System>

Another data processing system described in this embodiment includes the component 110, the component 120, and the component 130 (see FIG. 1).

The data processing system of one embodiment of the present invention can be composed of a data processing device having a function of the component 110, a data processing device having a function of the component 120, and a data processing device having a function of the component 130, for example. Note that the number of data processing devices constituting the data processing system of one embodiment of the present invention is one or more. For example, a plurality of data processing devices can be connected to each other using the network 51 to construct the data processing system of one embodiment of the present invention.

When the data processing system of one embodiment of the present invention is constituted with the plurality of data processing devices, loads relating to data processing can be dispersed.

### <Configuration Example 1 of Data Processing Device>

A configuration example 1 of the data processing device described in this embodiment can be used as the component 110. The configuration example 1 of the data processing device can be referred to as a client computer or the like. For example, a desktop computer can be used as the component 110.

The configuration example 1 of the data processing device can receive data input by the user of the data processing system of one embodiment of the present invention. The configuration example 1 of the data processing device can provide data output from the data processing system of one embodiment of the present invention to the user.

For example, dedicated application software or a web browser operates in the component 110. Via either of them, the user of the data processing system of one embodiment of the present invention can access the data processing system. Thus, the user can receive service using the data processing system of one embodiment of the present invention.

### <Configuration Example 2 of Data Processing Device>

This configuration example 2 of the data processing device described in this embodiment can be used as the component 120. For example, a workstation, a server computer, or a supercomputer can be used as the component 120.

The configuration example 2 of the data processing device preferably has a function of a parallel computer. When the data processing device with this configuration is used as a parallel computer, large-scale computation necessary for artificial intelligence (AI) learning and inference can be performed, for example.

Furthermore, the configuration example 2 of the data processing device can perform processing using a natural language processing model with use of AI.

For example, processing using a natural language model such as GPT-3 (registered trademark), GPT-3.5, GPT-4 (registered trademark), LaMDA, or Llama2, Llama3 can be performed.

### <Configuration Example 3 of Data Processing System Device>

The configuration example 3 of the data processing device described in this embodiment can be used as the component 130, for example. Note that the component 130 has a larger scale and higher computational capability than the component 120. For example, a large computer such as a server computer or a supercomputer can be used as the component 130.

The configuration example 3 of the data processing device preferably has a function of a parallel computer. When the data processing device with this configuration is used as a parallel computer, large-scale computation necessary for AI learning and inference can be performed, for example.

Furthermore, the configuration example 3 of the data processing device can perform processing using a natural language processing model with use of AI. In particular, it is possible to perform processing using a general-purpose language processing model capable of performing a variety of natural language processing tasks.

For example, processing using a natural language model such as GPT-3 (registered trademark), GPT-3.5, GPT-4 (registered trademark), LaMDA, Llama2, or Llama3 can be performed. In particular, it is preferable that processing using GPT-4 (registered trademark) be available. For example, processing using a language model that is larger in scale than a conventional natural language model can achieve more natural text generation, interaction, or the like.

Note that a service provider using the data processing system of one embodiment of the present invention does not necessarily have its own configuration example 3 of the data processing device. For example, a service provider can utilize part of the service that another company or the like provides using the configuration example 3 of the data processing device.

### <Configuration Example of Network 51>

The network 51 that can be used for the data processing system of one embodiment of the present invention can connect the plurality of data processing devices to each other. Thus, the plurality of data processing devices connected to each other can transmit and receive data to and from each other. Furthermore, loads of the data processing can be dispersed.

Note that for wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

For example, a local network can be used as the network 51. An intranet or an extranet can also be used as the network 51. For another example, a personal area network (PAN), a local area network (LAN), a campus area network (CAN), a metropolitan area network (MAN), a wide area network (WAN), or a global area network (GAN) can be used as the network 51.

For example, a global network can be used as the network 51. Specifically, the Internet, which is an infrastructure of the World Wide Web (WWW), can be used.

Furthermore, the service provider using the data processing system of one embodiment of the present invention can provide service using the data processing method of one embodiment of the present invention via the network 51, for example.

Note that in the case where the data processing system of one embodiment of the present invention is constructed in a local network, the possibility of leakage of confidential information can be lower than that in the case of using the Internet, for example.

### <Configuration Example 4 of Data Processing Device>

A data processing device 20 that can be used for the data processing system of one embodiment of the present invention includes, for example, an input unit 21, a storage unit 22, a processing unit 23, an output unit 24, and a transmission path 25 (see FIG. 8).

Although the block diagram in drawings attached to this specification illustrates components classified by their functions in independent blocks, it is difficult to classify actual components by their functions completely, and one component can have a plurality of functions.

For example, part of the processing unit 23 functions as the input unit 21 in some cases. In addition, one function can be involved in a plurality of components. For example, processing performed in the processing unit 23 is sometimes executed by a different data processing device depending on the processing.

### <<Input Unit 21>>

The input unit 21 can receive data from the outside of the data processing device. For example, the input unit 21 receives data via the network 51. Specifically, a device such as a personal computer having a communication port or a communication function can be used.

The input unit 21 supplies the received data to one or both of the storage unit 22 and the processing unit 23 via the transmission path 25.

### <<Storage Unit 22>>

The storage unit 22 has a function of storing a program to be executed by the processing unit 23. The storage unit 22 can also have a function of storing data generated by the processing unit 23 (e.g., an arithmetic operation result, an analysis result, or an inference result), data received by the input unit 21, and the like.

The storage unit 22 can include a database. The data processing device can include a database in addition to the storage unit 22. The data processing device can have a function of extracting data from a database outside the storage unit 22, the data processing device, or the data processing system. Alternatively, the data processing device can have a function of extracting data from both of its own database and an external database.

One or both of a storage and a file server can be used as the storage unit 22. In addition, a database in which a path of a file stored in the file server is recorded can be used as the storage unit 22.

The storage unit 22 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The storage unit 22 can include at least one of a NOSRAM (registered trademark) and a DOSRAM (registered trademark). The storage unit 22 can include a storage media drive. Examples of the storage media drive include a hard disk drive (HDD) and a solid state drive (SSD).

Note that the NOSRAM is an abbreviation for “nonvolatile oxide semiconductor random access memory (RAM)”. The NOSRAM refers to a memory in which a 2-transistor (2T) or 3-transistor (3T) gain cell is used as a memory cell and the transistor includes a metal oxide in its channel formation region (such a transistor is also referred to as an OS transistor). The OS transistor has an extremely low current that flows between a source and a drain in an off state, that is, an extremely low leakage current. The NOSRAM retains electric charge corresponding to data in memory cells by utilizing characteristics of extremely low leakage current, thereby capable of being used as a nonvolatile memory. In particular, the NOSRAM is capable of reading retained data without destruction (non-destructive reading), and thus is suitable for arithmetic processing in which only data reading operations are repeated many times. The NOSRAM can have large data capacity when stacked in layers, and thus, a semiconductor device in which the NOSRAM is used for a large-scale cache memory, a large-scale main memory, or a large-scale storage memory can have higher performance.

The DOSRAM is an abbreviation for “dynamic oxide semiconductor RAM” and refers to a RAM including a one-transistor (1T) and one-capacitor (IC) memory cell. The DOSRAM is a DRAM formed using an OS transistor and temporarily stores information sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. For example, indium oxide (InOₓ) or indium gallium zinc oxide (In—Ga—Zn oxide, also referred to as “IGZO”) can be used for the channel formation region. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium is. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide in the channel formation region may be, for example, a metal oxide that does not contain indium but contains any of zinc, gallium, and tin (e.g., zinc tin oxide and gallium tin oxide).

### <<Processing Unit 23>>

The processing unit 23 has a function of performing processing such as arithmetic operation, analysis, and inference with use of data supplied from one or both of the input unit 21 and the storage unit 22. The processing unit 23 can supply generated data (e.g., an arithmetic operation result, an analysis result, or an inference result) to one or both of the storage unit 22 and the output unit 24.

The processing unit 23 has a function of obtaining data from the storage unit 22. The processing unit 23 can also have a function of storing or registering data in the storage unit 22.

The processing unit 23 can include an arithmetic circuit, for example. The processing unit 23 can include, for example, a central processing unit (CPU). The processing unit 23 can also include a graphics processing unit (GPU). Furthermore, the processing unit 23 can include a neural processing unit/neural network processing unit (NPU).

The processing unit 23 can include a microprocessor such as a digital signal processor (DSP). The microprocessor can be achieved with a programmable logic device (PLD) such as a field programmable gate array (FPGA) or a field programmable analog array (FPAA). The processing unit 23 can also include a quantum processor. The processing unit 23 can interpret and execute instructions from various programs with use of a processor to process various kinds of data and control programs. The programs to be executed by the processor are stored in at least one of the storage unit 22 and a memory region of the processor.

The processing unit 23 can include a main memory. The main memory includes at least one of a volatile memory such as RAM and a nonvolatile memory such as a read only memory (ROM). The main memory can include at least one of the above-described NOSRAM and DOSRAM.

Examples of the RAM include a DRAM and an SRAM; a virtual memory space is assigned and utilized as a working space of the processing unit 23. An operating system, an application program, a program module, program data, a look-up table, and the like which are stored in the storage unit 22 are loaded into the RAM for execution. The data, program, and program module which are loaded into the RAM are each directly accessed and operated by the processing unit 23.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 23 can include one or both of an OS transistor and a transistor including silicon in its channel formation region (Si transistor).

The processing unit 23 preferably includes an OS transistor. Since the OS transistor has an extremely low off-state current, a long data retention period can be ensured with use of the OS transistor as a switch for retaining electric charge (data) that has flowed into a capacitor functioning as a memory element. When this feature is imparted to at least one of a register and a cache memory included in the processing unit, the processing unit can be operated only when needed, and otherwise can be off while information processed immediately before turning off the processing unit is stored in the memory element. In other words, normally-off computing is possible and the power consumption of the data processing system can be reduced.

The data processing device preferably uses AI for at least part of its processing.

In particular, the data processing device preferably uses an artificial neural network (ANN, hereinafter also simply referred to as a neural network). The neural network can be constructed with circuits (hardware) or programs (software).

In this specification and the like, the neural network indicates a general model having the capability of solving problems, which is modeled on a biological neural network and determines the connection strength of neurons by learning. The neural network includes an input layer, a middle layer (hidden layer), and an output layer.

In the description of the neural network in this specification and the like, determining a connection strength of neurons (also referred to as weight coefficients) from the existing information is referred to as “learning” in some cases.

In this specification and the like, drawing a new conclusion from a neural network formed with the connection strength obtained by learning is referred to as “inference” in some cases.

### <<Output Unit 24>>

The output unit 24 can output at least one of an arithmetic operation result, an analysis result, and an inference result in the processing unit 23 to the outside of the data processing device. For example, the output unit 24 can transmit data via the network 51. Specifically, a device such as a personal computer having a communication port or a communication function can be used. Furthermore, a device having a communication function may be used as the input unit 21 and the output unit 24.

### <<Transmission Path 25>>

The transmission path 25 has a function of transmitting data. Data transmission and reception between the input unit 21, the storage unit 22, the processing unit 23, and the output unit 24 can be performed via the transmission path 25. Specifically, a LAN or the Internet can be used.

Note that this embodiment can be combined with any of the other embodiments in this specification as appropriate.

### Embodiment 2

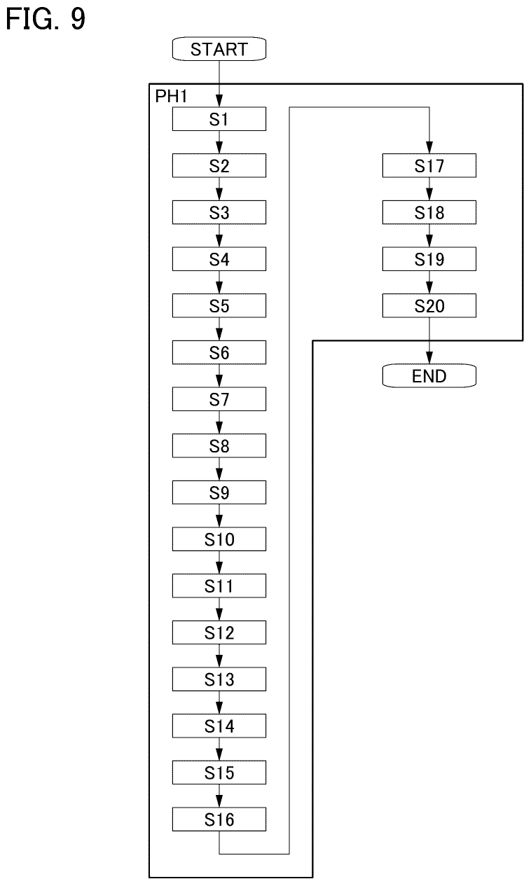

In this embodiment, a data processing method of one embodiment of the present invention will be described with reference to FIG. 9 to FIG. 15.

FIG. 9 is a flow diagram showing a data processing method of one embodiment of the present invention.

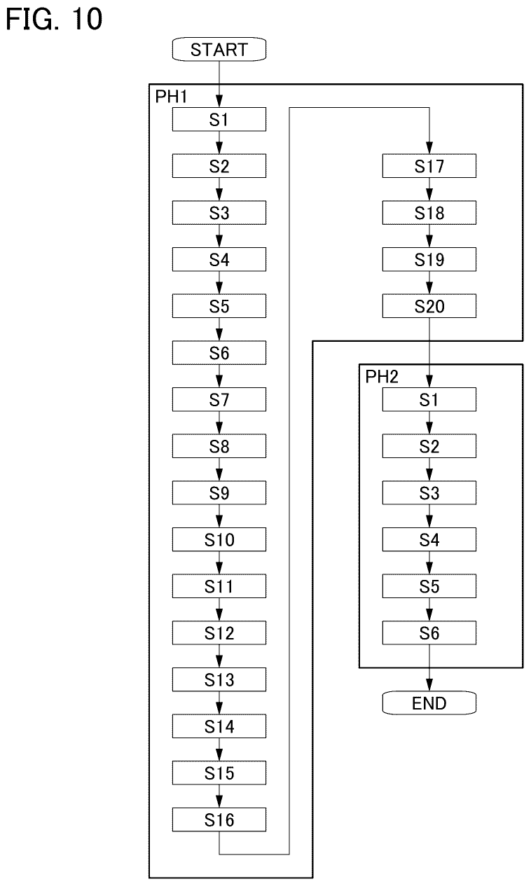

FIG. 10 is a flow diagram showing a data processing method of one embodiment of the present invention.

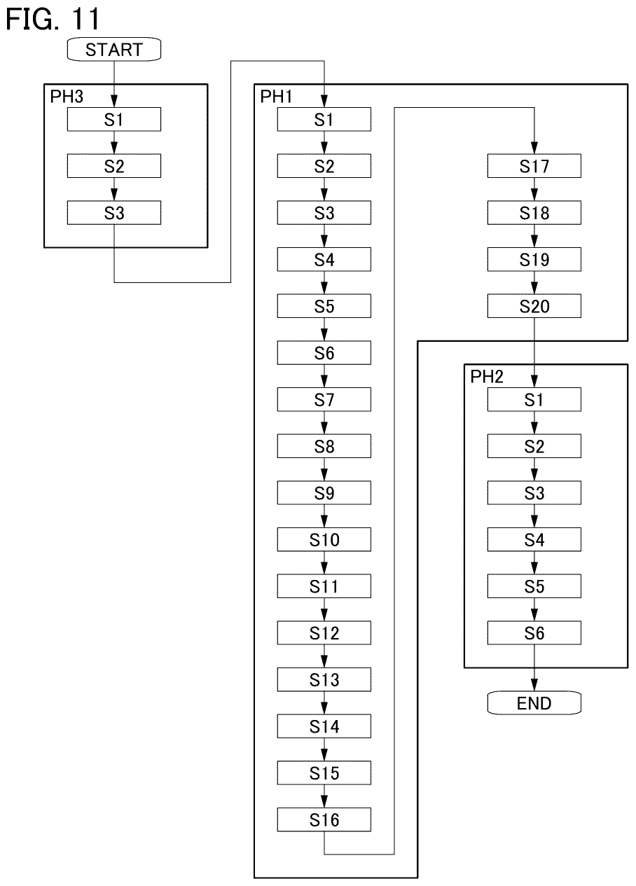

FIG. 11 is a flow diagram showing a data processing method of one embodiment of the present invention.

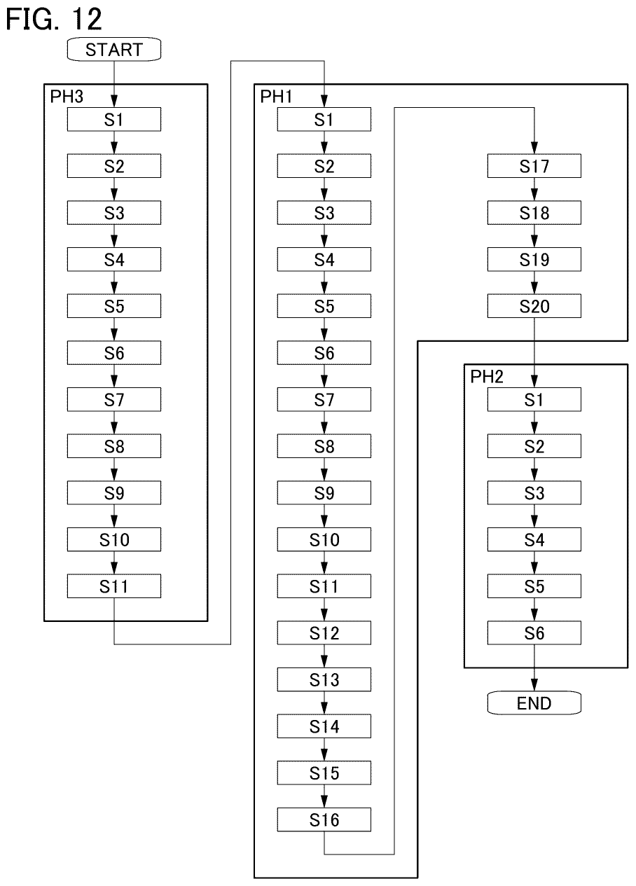

FIG. 12 is a flow diagram showing a data processing method of one embodiment of the present invention.

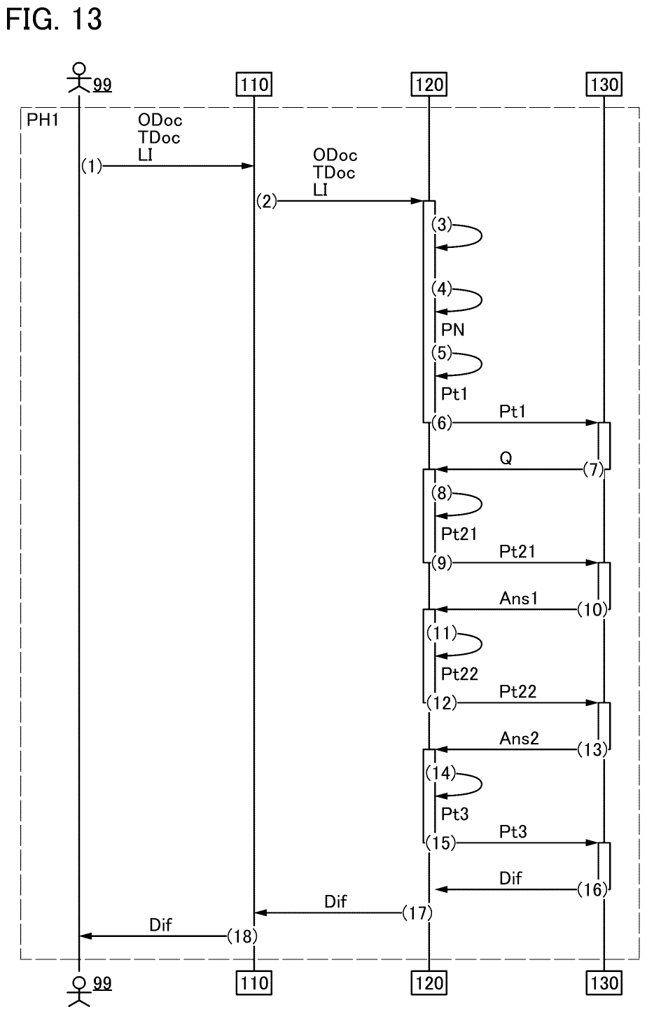

FIG. 13 is a sequence diagram showing a data processing method of one embodiment of the present invention.

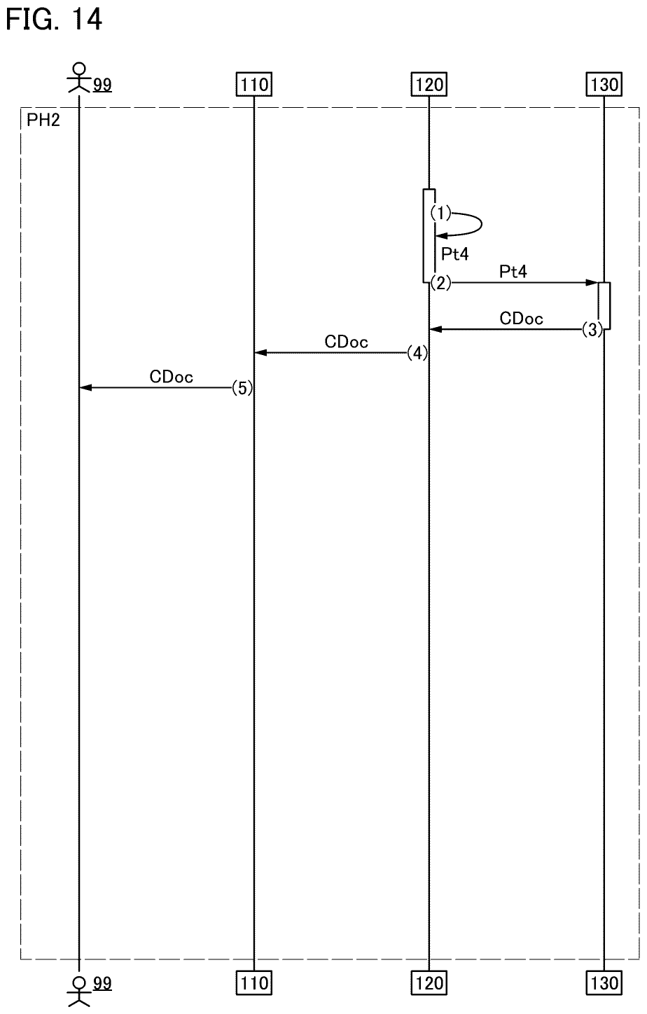

FIG. 14 is a sequence diagram showing a data processing method of one embodiment of the present invention.

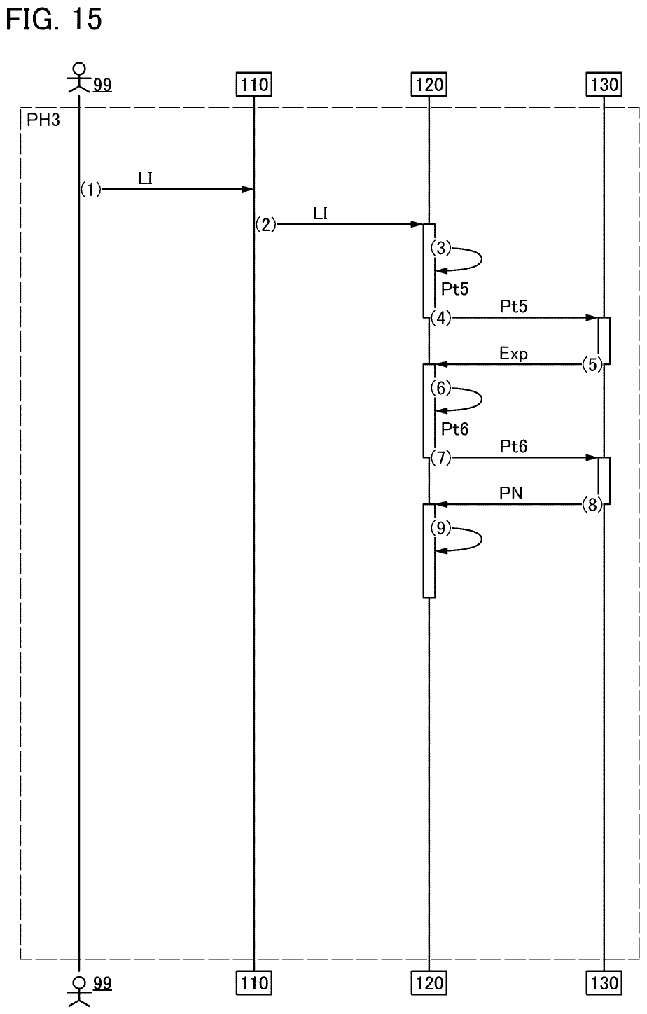

FIG. 15 is a sequence diagram showing a data processing method of one embodiment of the present invention.

### <Example 1 of Data Processing Method>

The data processing method of one embodiment of the present invention includes Phase PH1 (see FIG. 9).

### <Example of Phase PH1>

Phase PH1 includes Step S1 to Step S20.

### <<Step S1>>

In Step S1 of Phase PH1, the component 110 receives the original document ODoc, the translated document TDoc, and the information LI and transmits them to the component 120. For example, the user 99 of the data processing system inputs the original document ODoc, the translated document TDoc, and the information LI. Step S1 corresponds to an arrow extending from (1) in FIG. 13 and an arrow extending from (2) therein.

Note that the original document ODoc is written in the language Lng1, and the translated document TDoc is the original document ODoc translated from the language Lng1 into the language Lng2. The information LI includes information specifying the language Lng1 and the language Lng2.

### <<Step S2>>

In Step S2 of Phase PH1, the component 120 receives the original document ODoc, the translated document TDoc, and the information LI and shares them in the component 120. Step S2 corresponds to an arrow extending from (3) in FIG. 13.

The component 120 includes the subcomponent 120A and the subcomponent 120B. The subcomponent 120A has a function of executing processing using the database DB and the management system DBMS. The database DB stores the points to be noted PN. Note that the points to be noted PN are matters that require attention in translation from the language Lng1 into the language Lng2.

### <<Step S3>>

In Step S3 of Phase PH1, the subcomponent 120A specifies the points to be noted PN from the information LI with use of the management system DBMS and shares the points to be noted PN in the component 120. Step S3 corresponds to an arrow extending from (4) in FIG. 13.

### <<Step S4>>

In Step S4 of Phase PH1, the subcomponent 120B creates the prompt Pt1 and transmits it to the component 130. Step S4 corresponds to an arrow extending from (5) in FIG. 13 and an arrow extending from (6) therein.

The prompt Pt1 includes the instruction g1 ( ), the original document ODoc, and the points to be noted PN. The instruction g1 ( ) includes a procedure for generating the question Q relating to the points to be noted PN. Note that the question Q is a question that can be answered from the description of the original document ODoc.

### <<Step S5>>

In Step S5 of Phase PH1, the component 130 receives the prompt Pt1 and generates the question Q with use of the large language model LLM.

### <<Step S6>>

In Step S6 of Phase PH1, the component 130 transmits the question Q to the component 120. Step S6 corresponds to an arrow extending from (7) in FIG. 13.

### <<Step S7>>

In Step S7 of Phase PH1, the component 120 receives the question Q and shares it in the component 120.

### <<Step S8>>

In Step S8 of Phase PH1, the subcomponent 120B creates the prompt Pt21 and transmit it to the component 130. Step S8 corresponds to an arrow extending from (8) in FIG. 13 and an arrow extending from (9) therein.

The prompt Pt21 includes the instruction g21 ( ), the question Q, and the original document ODoc. The instruction g21 ( ) includes a procedure for generating the answer Ans1 to the question Q from the description of the original document ODoc.

### <<Step S9>>

In Step S9 of Phase PH1, the component 130 receives the prompt Pt21 and generates the answer Ans1 with use of the large language model LLM.

### <<Step S10>>

In Step S10 of Phase PH1, the component 130 transmits the answer Ans1 to the component 120. Step S10 corresponds to an arrow extending from (10) in FIG. 13.

### <<Step S11>>

In Step S11 of Phase PH1, the component 120 receives the answer Ans1 and shares it in the component 120.

### <<Step S12>>

In Step S12 of Phase PH1, the subcomponent 120B creates the prompt Pt22 and transmits it to the component 130. Step S12 corresponds to an arrow extending from (11) in FIG. 13 and an arrow extending from (12) therein.

The prompt Pt22 includes the instruction g22 ( ), the question Q, and the translated document TDoc. The instruction g22 ( ) includes a procedure for generating the answer Ans2 to the question Q from the description of the translated document TDoc.

### <<Step S13>>

In Step S13 of Phase PH1, the component 130 receives the prompt Pt22 and generates the answer Ans2 with use of the large language model LLM.

### <<Step S14>>

In Step S14 of Phase PH1, the component 130 transmits the answer Ans2 to the component 120. Step S14 corresponds to an arrow extending from (13) in FIG. 13.

### <<Step S15>>

In Step S15 of Phase PH1, the component 120 receives the answer Ans2 and shares it in the component 120.

### <<Step S16>>

In Step S16 of Phase PH1, the subcomponent 120B creates the prompt Pt3 and transmits it to the component 130. Step S16 corresponds to an arrow extending from (14) in FIG. 13 and an arrow extending from (15) therein.

The prompt Pt3 includes an instruction g3 ( ) and a pair of answers POA. The instruction g3 ( ) includes a procedure for generating the difference Dif from the pair of answers POA. Note that the pair of answers POA includes the answer Ans1 and the answer Ans2.

### <<Step S17>>

In Step S17 of Phase PH1, the component 130 receives the prompt Pt3 and generates the difference Dif with use of the large language model LLM.

### <<Step S18>>

In Step S18 of Phase PH1, the component 130 transmits the difference Dif to the component 120. Step S18 corresponds to an arrow extending from (16) in FIG. 13.

### <<Step S19>>

In Step S19 of Phase PH1, the component 120 receives the difference Dif and transmits it to the component 110. Step S19 corresponds to an arrow extending from (17) in FIG. 13.

### <<Step S20>>

In Step S20 of Phase PH1, the component 110 receives the difference Dif and provides it to the user 99 of the data processing system, for example. Step S20 corresponds to an arrow extending from (18) in FIG. 13.

Thus, with the points to be noted PN in mind in translation from the language Lng1 into the language Lng2, the question Q that inquires about the content described in the original document Odoc can be generated. Furthermore, by comparing the answers Ans1 and Ans2 to the question Q, the difference Dif generated between the original document ODoc and the translated document TDoc can be identified. For example, it is possible to provide the difference Dif to a user of the data processing system and ask the user whether the correction of the translated document TDoc is necessary. As a result, a novel data processing method that is highly convenient, useful, or reliable can be provided.

### <Example 2 of Data Processing Method>

The data processing method of one embodiment of the present invention includes Phase PH2 (see FIG. 10).

### <Example of Phase PH2>

Phase PH2 follows Phase PH1, and Phase PH2 includes a first step S1 to a sixth step S6.

### <<Step S1>>

In Step S1 of Phase PH2, the component 120 shares the difference Dif in the component 120.

### <<Step S2>>

In Step S2 of Phase PH2, the subcomponent 120B creates the prompt Pt4 and transmits it to the component 130. Step S2 corresponds to an arrow extending from (1) in FIG. 14 and an arrow extending from (2) therein.

The prompt Pt4 includes the instruction g4 ( ), the translated document TDoc, and the difference Dif. Note that the instruction g4 ( ) includes a procedure for generating the corrected document CDoc from the translated document TDoc with reference to the difference Dif.

### <<Step S3>>

In Step S3 of Phase PH2, the component 130 receives the prompt Pt4 and generates the corrected document CDoc with use of the large language model LLM.

### <<Step S4>>

In Step S4 of Phase PH2, the component 130 transmits the corrected document CDoc to the component 120. Step S4 corresponds to an arrow extending from (3) in FIG. 14.

### <<Step S5>>

In Step S5 of Phase PH2, the component 120 receives the corrected document CDoc and transmits it to the component 110. Step S5 corresponds to an arrow extending from (4) in FIG. 14.

### <<Step S6>>

In Step S6 of Phase PH2, the component 110 receives the corrected document CDoc and provide it to the user 99 of the data processing system, for example. Note that Step S6 corresponds to an arrow extending from (5) in FIG. 14.

Accordingly, the corrected document CDoc can be generated from the translated document TDoc with reference to the difference Dif generated between the original document Odoc and the translated document Tdoc which is identified by comparing the answers Ans1 and Ans2 to the question Q. As a result, a novel data processing method that is highly convenient, useful, or reliable can be provided.

### <Example 3 of Data Processing Method>

The data processing method of one embodiment of the present invention includes Phase PH3.

### <Example of Phase PH3>

Phase PH1 follows Phase PH3, and Phase PH3 includes the first step S1 to a third step S3 (see FIG. 11).

### <<Step S1>>

In Step S1 of Phase PH3, the component 110 receives the information LI and the points to be noted PN and transmits them to the component 120. For example, the user 99 of the data processing system inputs the information LI.

### <<Step S2>>

In Step S2 of Phase PH3, the component 120 receives the information LI and the points to be noted PN and shares them in the component 120.

### <<Step S3>>

In Step S3 of Phase PH3, the subcomponent 120A stores the information LI and the points to be noted PN in the database DB with use of the management system DBMS.

Thus, for example, a user of the information processing system can register the points to be noted PN in translation from the language Lng1 into the language Lng2 in the data processing system. For example, the user of the data processing system can input the information LI to the data processing system to call up the points to be noted PN. As a result, a novel data processing method that is highly convenient, useful, or reliable can be provided.

### <Example 4 of Data Processing Method>

The data processing method of one embodiment of the present invention includes Phase PH3.

### <Example of Phase PH3>

Phase PH1 follows Phase PH3, and Phase PH3 includes the first step S1 to an eleventh step S11 (see FIG. 12).

### <<Step S1>>

In Step S1 of Phase PH3, the component 110 receives the information LI and transmits it in the component 120. For example, the user 99 of the data processing system inputs the information LI. Step S1 corresponds to an arrow extending from (1) in FIG. 15 and an arrow extending from (2) therein.

### <<Step S2>>

In Step S2 of Phase PH3, the component 120 receives the information LI and shares it in the component 120.

### <<Step S3>>

In Step S3 of Phase PH3, the subcomponent 120B creates the prompt Pt5 and transmits it to the component 130. Step S3 corresponds to an arrow extending from (3) in FIG. 15 and an arrow extending from (4) therein.

The prompt Pt5 includes the instruction g5 ( ) and the information LI. Note that the instruction g5 ( ) includes a procedure for generating the explanation Exp by extracting the feature of the language Lng1 and the feature of the language Lng2.

### <<Step S4>>

In Step S4 of Phase PH3, the component 130 receives the prompt Pt5 and generates the explanation Exp with use of the large language model LLM.

### <<Step S5>>

In Step S5 of Phase PH3, the component 130 transmits the explanation Exp to the component 120. Step S5 corresponds to an arrow extending from (5) in FIG. 15.

### <<Step S6>>

In Step S6 of Phase PH3, the component 120 receives the explanation Exp and shares it in the component 120.

### <<Step S7>>

In Step S7 of Phase PH3, the subcomponent 120B creates the prompt Pt6 and transmits it to the component 130. Step S7 corresponds to an arrow extending from (6) in FIG. 15 and an arrow extending from (7) therein.

The prompt Pt6 includes the instruction g6 ( ) and the explanation Exp. The instruction g6 ( ) includes a procedure for generating the points to be noted PN in translation from the language Lng1 into the language Lng2 in consideration of the explanation Exp.

### <<Step S8>>

In Step S8 of Phase PH3, the component 130 receives the prompt Pt6 and generates the points to be noted PN with use of the large language model LLM.

### <<Step S9>>

In Step S9 of Phase PH3, the component 130 transmits the points to be noted PN to the component 120. Step S9 corresponds to an arrow extending from (8) in FIG. 15.

### <<Step S10>>

In Step S10 of Phase PH3, the component 120 receives the points to be noted PN and shares it in the component 120.

### <<Step S11>>

In Step S11 of Phase PH3, the subcomponent 120A links the information LI and the points to be noted PN and registers them in the database DB with use of the management system DBMS. Note that Step S11 corresponds to an arrow extending from (9) in FIG. 15.

Thus, in consideration of the features of the language Lng1 and the language Lng2, the points to be noted PN in translation from the language Lng1 into the language Lng2 can be summarized. As a result, a novel data processing method that is highly convenient, useful, or reliable can be provided.

Note that this embodiment can be combined with any of the other embodiments in this specification as appropriate.

This application is based on Japanese Patent Application Serial No. 2024-165855 filed with Japan Patent Office on Sep. 25, 2024, the entire contents of which are hereby incorporated by reference.

What is claimed is:

1. A data processing system comprising:
a first component;
a second component; and
a third component,
wherein the first component is configured to receive an original document and a translated document and transmit the original document and the translated document to the third component and to receive a difference and providing the difference,
wherein the original document is written in a first language,
wherein the translated document is a translated document of the original document from the first language into a second language,
wherein the difference includes a difference between the original document and the translated document,
wherein the second component is configured to receive a first prompt and transmit a question to the third component, to receive a second prompt and transmit a first answer to the third component, to receive a third prompt and transmit a second answer to the third component, to receive a fourth prompt and transmit the difference to the third component, and to perform processing using a large language model,
wherein the large language model is configured to generate the question in accordance with the first prompt, to generate the first answer in accordance with the second prompt, to generate the second answer in accordance with the third prompt, and to generate the difference in accordance with the fourth prompt,
wherein the third component is configured to receive the original document, the translated document, the question, the first answer, the second answer, and the difference and share the original document, the translated document, the question, the first answer, the second answer, and the difference in the third component, to transmit the first prompt, the second prompt, the third prompt, and the fourth prompt to the second component, and to transmit the difference to the first component,
wherein the third component comprises a first subcomponent and a second subcomponent,
wherein the first subcomponent is configured to perform processing using a database and a management system and to share a point to be noted in the third component,
wherein the database stores the point to be noted,
wherein the point to be noted is a matter that requires attention in translation from the first language into the second language,
wherein the second subcomponent is configured to create the first prompt, the second prompt, the third prompt, and the fourth prompt,
wherein the first prompt comprises a first instruction, the original document, and the point to be noted,
wherein the first instruction comprises a procedure for generating the question related to the point to be noted,
wherein the question is a question that can be answered from the original document,
wherein the second prompt comprises a second instruction, the question, and the original document,
wherein the second instruction comprises a procedure for generating the first answer to the question based on description of the original document,
wherein the third prompt comprises a third instruction, the question, and the translated document,
wherein the third instruction comprises a procedure for generating the second answer to the question based on description of the translated document,
wherein the fourth prompt comprises a fourth instruction and a pair of answers,
wherein the fourth instruction comprises a procedure for generating the difference from the pair of answers, and
wherein the pair of answers comprises the first answer and the second answer.

2. The data processing system according to claim 1,
wherein the first component is configured to receive a corrected document and provide the corrected document,
wherein the second component is configured to receive a fifth prompt and transmit the corrected document to the third component,
wherein the large language model is configured to generate the corrected document in accordance with the fifth prompt,
wherein the third component is configured to transmit the fifth prompt to the second component,
wherein the second subcomponent is configured to create the fifth prompt,
wherein the fifth prompt comprises a fifth instruction, the translated document, and the difference, and
wherein the fifth instruction comprises a procedure for generating the corrected document from the translated document with reference to the difference.

3. The data processing system according to claim 1,
wherein the first component is configured to receive information and the point to be noted and transmit the information and the point to be noted to the third component,
wherein the information comprises information specifying the first language and the second language,
wherein the third component is configured to receive the information and the point to be noted and share the information and the point to be noted in the third component, and
wherein the first subcomponent is configured to link the information and the point to be noted and register the information and the point to be noted in the database with use of the management system.

4. The data processing system according to claim 1,
wherein the first component is configured to receive information and transmit the information to the third component,
wherein the information comprises information specifying the first language and the second language,
wherein the second component is configured to receive a sixth prompt and transmit explanation to the third component and to receive a seventh prompt and transmit the point to be noted to the third component,
wherein the large language model is configured to generate the explanation in accordance with the sixth prompt and to generate the point to be noted in accordance with the seventh prompt,
wherein the third component is configured to receive the information and share the information in the third component and to transmit the sixth prompt and the seventh prompt to the second component,
wherein the second subcomponent is configured to create the sixth prompt and the seventh prompt,
wherein the sixth prompt comprises a sixth instruction and the information,
wherein the sixth instruction comprises a procedure for generating the explanation by extracting a feature of the first language and a feature of the second language,
wherein the seventh prompt comprises a seventh instruction and the explanation,
wherein the seventh instruction comprises a procedure for generating the point to be noted in translation from the first language into the second language in consideration of the explanation, and
wherein the first subcomponent is configured to link the information and the point to be noted and register the information and the point to be noted in the database with use of the management system.

5. A data processing method comprising a first phase,
wherein the first phase comprises a first step to a twentieth step,
wherein in the first step of the first phase, a first component receives an original document, a translated document, and information and transmits the original document, the translated document, and the information to a second component,
wherein the original document is written in a first language,
wherein the translated document is a translated document of the original document from the first language into the second language,
wherein the information comprises information specifying the first language and the second language,
wherein in the second step of the first phase, the second component receives the original document, the translated document, and the information and shares the original document, the translated document, and the information in the second component,
wherein the second component comprises a first subcomponent and a second subcomponent,
wherein the first subcomponent is configured to perform processing with use of a database and a management system,
wherein the database stores a point to be noted,
wherein the point to be noted is a matter that requires attention in translation from the first language into the second language,
wherein in the third step of the first phase, the first subcomponent specifies the point to be noted from the information with use of the management system and shares the point to be noted in the second component,
wherein in the fourth step of the first phase, the second subcomponent creates a first prompt and transmits the first prompt to a third component,
wherein the first prompt comprises a first instruction, the original document, and the points to be noted,
wherein the first instruction comprises a procedure for generating a question related to the point to be noted,
wherein the question can be answered from description of the original document,
wherein in the fifth step of the first phase, the third component receives the first prompt and generates the question with use of a large language model,
wherein in the sixth step of the first phase, the third component transmits the question to the second component,
wherein in the seventh step of the first phase, the second component receives the question and,
wherein in the eighth step of the first phase, the second subcomponent creates a second prompt and transmits the second prompt to the third component,
wherein the second prompt comprises a second instruction, the question, and the original document,
wherein the second instruction comprises a procedure for generating a first answer to the question based on description of the original document,
wherein in the ninth step of the first phase, the third component receives the second prompt and generates the first answer with use of the large language model,
wherein in the tenth step of the first phase, the third component transmits the first answer to the second component,
wherein in the eleventh step of the first phase, the second component receives the first answer and shares the first answer in the second component,
wherein in the twelfth step of the first phase, the second subcomponent creates a third prompt and transmits the third prompt to the third component,
wherein the third prompt comprises a third instruction, the question, and the translated document,
wherein the third instruction comprises a procedure for generating a second answer to the question based on description of the translated document,
wherein in the thirteenth step of the first phase, the third component receives the third prompt and generates the second answer with use of the large language model,
wherein in the fourteenth step of the first phase, the third component transmits the second answer to the second component,
wherein in the fifteenth step of the first phase, the second component receives the second answer and shares the second answer in the second component,
wherein in the sixteenth step of the first phase, the second subcomponent creates a fourth prompt and transmits the fourth prompt to the third component,
wherein the fourth prompt comprises a fourth instruction and a pair of answers,
wherein the fourth instruction comprises a procedure for generating a difference from the pair of answers,
wherein the pair of answers comprises the first answer and the second answer,
wherein in the seventeenth step of the first phase, the third component receives the fourth prompt and generates the difference with use of the large language model,
wherein in the eighteenth step of the first phase, the third component transmits the difference to the second component,
wherein in the nineteenth step of the first phase, the second component receives the difference and transmits the difference to the first component, and
wherein in the twentieth step of the first phase, the first component receives the difference.

6. The data processing method according to claim 5, further comprising a second phase,
wherein the second phase follows the first phase,
wherein the second phase comprises a first step to a sixth step,
wherein in the first step of the second phase, the second component shares the difference in the second component,
wherein in the second step of the second phase, the second subcomponent creates a fifth prompt and transmits the fifth prompt to the third component,
wherein the fifth prompt comprises a fifth instruction, the translated document, and the difference,
wherein the fifth instruction comprises a procedure for generating a corrected document from the translated document with reference to the difference,
wherein in the third step of the second phase, the third component receives the fifth prompt and generates the corrected document with use of the large language model,
wherein in the fourth step of the second phase, the third component transmits the corrected document to the second component,
wherein in the fifth step of the second phase, the second component receives the corrected document and transmits the corrected document to the first component, and
wherein in the sixth step of the second phase, the first component receives the corrected document and provides the corrected document.

7. The data processing method according to claim 5, further comprising a third phase,
wherein the first phase follows the third phase,
wherein the third phase comprises a first step to a third step,
wherein in the first step of the third phase, the first component receives the information and the point to be noted and transmits the information and the point to be noted to the second component,
wherein in the second step of the third phase, the second component receives the information and the point to be noted and shares the information and the point to be noted in the second component, and
wherein in the third step of the third phase, the first subcomponent stores the information and the point to be noted in the database with use of the management system.

8. The data processing method according to claim 5, further comprising a third phase,
wherein the first phase follows the third phase,
wherein the third phase comprises a first step to an eleventh step,
wherein in the first step of the third phase, the first component receives the information and transmits the information to the second component,
wherein in the second step of the third phase, the second component receives the information and shares the information in the second component,
wherein in the third step of the third phase, the second subcomponent creates a sixth prompt and transmits the sixth prompt to the third component,
wherein the sixth prompt comprises a sixth instruction and the information,
wherein the sixth instruction comprises a procedure for extracting a feature of the first language and a feature of the second language to generate explanation,
wherein in the fourth step of the third phase, the third component receives the sixth prompt and generates the explanation with use of the large language model,
wherein in the fifth step of the third phase, the third component transmits the explanation to the second component,
wherein in the sixth step of the third phase, the second component receives the explanation and shares the explanation in the second component,
wherein in the seventh step of the third phase, the second subcomponent creates a seventh prompt and transmits the seventh prompt to the third component,
wherein the seventh prompt comprises a seventh prompt and the explanation,
wherein the seventh instruction comprises a procedure for generating the point to be noted in translation from the first language into the second language in consideration of the explanation,
wherein in the eighth step of the third phase, the third component receives the seventh prompt and generates the point to be noted with use of the large language model,
wherein in the ninth step of the third phase, the third component transmits the point to be noted to the second component,
wherein in the tenth step of the third phase, the second component receives the point to be noted and shares the point to be noted in the second component, and
wherein in the eleventh step of the third phase, the first subcomponent links the information and the point to be noted and registers the information and the point to be noted in the database with use of the management system.
